(19) United States
(12) Patent Application Publication
(10) Pub. No.: US 2003/0045947 A1
(43) Pub. Date: Mar. 6, 2003

(54) System, method and computer program product for controlling the operation of motion devices by directly implementing electronic simulation information

(75) Inventor: Robert R. Wampler, Augusta, KS (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company

(21) Appl. No.: 09/942,872

(22) Filed: Aug. 30, 2001

(51) Int. Cl. G05B 11/01; G05B 13/02; G05B 19/18

(52) U.S. Cl. 700/32; 700/31; 700/19; 700/20; 700/46

(57) ABSTRACT

A system for controlling the operation of at least one motion device, where the motion devices comprise at least one controllable element, includes a setup component and at least one motion command component. The setup component is capable of extracting process information from electronic simulation information, and thereafter formatting the process information into neutral process information. The motion command components are each associated with at least one motion device, and are capable of receiving the neutral process information from the setup component. Each motion command component is capable of interpreting the received neutral process information into operation information for the controllable elements of each respective motion device, where the operation information depends on a type of the at least one motion device. Each motion command component is further capable of distributing the operation information to the controllable elements of each respective motion device.

### FIELD OF THE INVENTION

The present invention relates to systems and methods for controlling the operation of a motion device and, more particularly, to systems and methods for controlling the operation of a motion device by directly implementing electronic simulation information.

### BACKGROUND OF THE INVENTION

In many motion systems today, computers are used throughout the process to aid in the operation of motion devices, such as machine tools. In this regard, computer-aided design (CAD) systems help designers prepare drawings, specifications, parts lists, and other design-related elements using computer programs that are graphics and calculations intensive. Referring to FIG. 1, in modem CAD systems, engineers typically design end products by geometrically modeling the part in three-dimensions (3D) with a CAD computer program to obtain an electronic definition for motion devices and other objects, such as components, sub-assemblies and major assemblies (Block 10).

In many conventional motion systems, designing and developing complex CAD definitions for many modem end products is a powerful but expensive and intricate process. For example, in conventional manufacturing systems in the aircraft industry, balancing aircraft performance and design against manufacturing capability and configuration control requirements is a fundamental process. This balancing process defines the degree of success for an aircraft program and the manufacturer as a whole. The effort and energy expended defining and refining these issues consume significant resources from virtually every component of the manufacturer. A key product of this enterprise wide effort is the CAD definition of the components, sub-assemblies, and major assemblies including their respective tolerance definitions. The bulk of the aircraft manufacturing and assembly process revolves around efficiently achieving the constraints defined in and between CAD models of the components and assemblies.

In many modem motion systems, once a CAD model for a motion device including respective components and/or assemblies has been defined, computer-aided manufacturing (CAM) systems are used to allow motion devices, such as NC devices (i.e., machine tools), to operate without a lot of manual interaction. In this regard, generally in CAM systems, once the planning and arrangement of NC devices for a particular manufacturing process have been set up, machining the parts can proceed automatically, often untouched by human hands.

One part of most motion systems is a process whereby motion commands for the motion devices are created and thereafter processed into operation information for use by the motion devices. In this regard, one part of most CAM systems is a process called numerical control (NC) set creation, in which an NC programmer typically creates a set of “high level” instructions designating the precise locations for machining each of the features of the component, including those of a pattern, on the component. (Block 12).

Once the NC set has been created and stored, these instructions are transmitted to a post processor, typically by the NC programmer. The post processor is in communication with a machine control unit (MCU) (i.e., machine tool controller) of the NC device. The post processor adapts the “high level” instructions of the NC program to the specific requirements of the NC device and its MCU, and outputs a work piece instruction understandable to the MCU in the form of machine control data (MCD). (Block 14)

To help ensure the motion devices operate as error free as possible, many modem motion systems employ electronic verification systems. In this regard, in the manufacturing industry, electronic verification systems are used to make sure the MCU and NC device produce an error free part as close to the CAD design as possible. NC verification systems simulate MCD to detect part program errors and bad or rapid NC device operations. (Block 16). In this regard, NC verification systems allow parts to be machined correctly the first time, while eliminating expensive and time consuming dry runs and proofing, and reducing material scrap and overall cost.

After the operation of the motion device has been verified, the operation information used to actually operate the motion device is released for use by the motion devices. In the manufacturing industry, for example, once a part has been verified, such as with an NC verification system, the MCD is released for use by the MCU. (Block 18). In many complex manufacturing companies, multiple machine tool controllers within a machine shop are connected to a central mainframe database over dedicated communication systems, such as serial communication, block transfer read communication or local area network (LAN) communication, to form a direct numerical control (DNC) system. In conventional DNC systems, the MCD's are housed within the mainframe database and are transferred to the various machine tool controllers, as desired. In this regard, the MCD is typically downloaded and/or crossloaded, or otherwise transferred, to the MCU to thereby control the NC device. (Block 20).

Once received by the motion devices, controllable elements of the motion devices receive relevant information from the operation information to thereby control the motion device. In the manufacturing industry, after the MCU receives the MCD, the MCU sequentially accesses and processes the instructions from the MCD to thereby numerically control the NC device. (Blocks 22 and 24). Various instructions are interpreted into signals directly actionable by the drives and motors of the NC device. (Block 26) And other instructions from the MCD, such as auxiliary machine function commands, are passed through a programmable logic controller (PLC) to the switches and relays of the NC device. (Block 28). Based on the instructions provided to the NC device, the NC device performs machine operations to thereby manufacture the desired part.

Whereas conventional motion systems adequately operate motion devices, the process requires significant resources in terms of both time and money. Additionally, due to the uniqueness of many devices utilized to control the motion devices, such as the MCU's and the specific motion commands implemented by the NC device manufacturer, operation information is generally not transportable. In this regard, any modification to the form, fit or function of the MCU, NC device or part requires repeating the entire process to produce the part. Additionally, any new or added MCU, NC device or part requires repeating the entire process. As such, it would be desirous to develop a system and method of controlling a motion device that commands fewer resources (in terms of time and money) to implement, and requires fewer resources to modify.

### SUMMARY OF THE INVENTION

In light of the foregoing background, the present invention provides a system, method and computer program product for controlling the operation of a device by directly implementing electronic simulation information. By implementing the electronic simulation information, the system and method of the present invention eliminate many of the steps in the creation, verification and use of motion device commands, as required by conventional methods. As such, the system and method of the present invention reduce the amount of resources (in terms of time and money) required to implement and/or modify operation of a motion device.

According to one embodiment, the present invention provides a system for controlling the operation of at least one motion device, such as a machine tool, comprising at least one controllable element. The system includes a setup component and a motion command component. The setup component is capable of extracting process information from electronic simulation information. In this regard, the electronic simulation information includes information relating to the operation of the motion devices. The setup component is further capable of formatting the process information into neutral process information in a format independent of the format of the electronic simulation information.

The system further includes the motion command components, each of which is associated with at least one motion device, and is capable of receiving the neutral process information from the setup component. Each motion command component is further capable of interpreting the neutral process information into operation information for the controllable elements of each respective motion device, where the operation information depends on the type of the motion devices. Additionally, each motion command component is capable of distributing the operation information to the controllable elements of each respective motion device to thereby control the operation of the respective motion devices.

In another embodiment, the motion devices comprise a plurality of motion devices. In this embodiment, the setup component is capable of interpreting the neutral process information into operation information specific to the type of each of the plurality of motion devices. Also in this embodiment, each motion command component is capable of distributing the operation information to the controllable elements of each respective motion device of the plurality of motion devices. In yet another embodiment, the electronic simulation information comprises electronic simulation information in at least one format. In this embodiment, the setup component is capable of formatting the process information extracted from the electronic simulation information into the neutral process information in a neutral format independent of the formats of the electronic simulation information.

In one embodiment, the motion devices operate according to operation information in at least one format. However, the setup component is preferably capable of formatting the process information into neutral process information in a neutral format that is also independent of the formats of the operation information of the motion devices. Each motion command component is preferably capable of interpreting the neutral process information into operation information in the format of each respective motion device.

In operation, a method of controlling the operation of the motion devices by directly implementing electronic simulation information, according to one embodiment of the present invention, includes extracting the process information from the electronic simulation information. Next, the process information is formatted into the neutral process information. The neutral process information is then interpreted into operation information for each of the controllable elements, where the operation information depends on a type of the respective motion device. After interpreting the neutral process information, the operation information is distributed to the controllable elements of the motion devices to thereby control the operation of the motion devices.

In embodiments where the at least one motion device comprises a plurality of motion devices, the neutral process information is interpreted into operation information specific to the type of each of the plurality of motion devices. Also, the operation information is distributed to the controllable elements of respective motion devices of the plurality of motion devices. In embodiments where the electronic simulation information comprises electronic simulation information in at least one format, the process information extracted from the electronic simulation information is formatted into the neutral process information in a neutral format independent of the formats of the electronic simulation information.

In embodiments where the motion devices operate according to operation information in at least one format, the neutral process information is interpreted into operation information in the formats of the motion devices. However, the process information is typically formatted into the neutral process information in a neutral format that is also independent of the at least one format of the operation information of the at least one motion device.

Thus, the present invention provides a system, method and computer program product for controlling the operation of a motion device by directly implementing electronic simulation information. By implementing the electronic simulation information and converting the process information into neutral process information, the system, method and computer product of the present invention can accept simulation information in multiple different formats and can supply operation information to multiple different motion devices. As such, the system and method of the present invention reduce the amount of resources (in terms of time and money) required to implement and/or modify control of a motion device, as compared to conventional motion systems.

### BRIEF DESCRIPTION OF THE DRAWINGS

Having thus described the invention in general terms, reference will now be made to the accompanying drawings, which are not necessarily drawn to scale, and wherein:

FIG. 1 is a flow diagram illustrating the steps in designing and manufacturing a part according to a conventional manufacturing system;

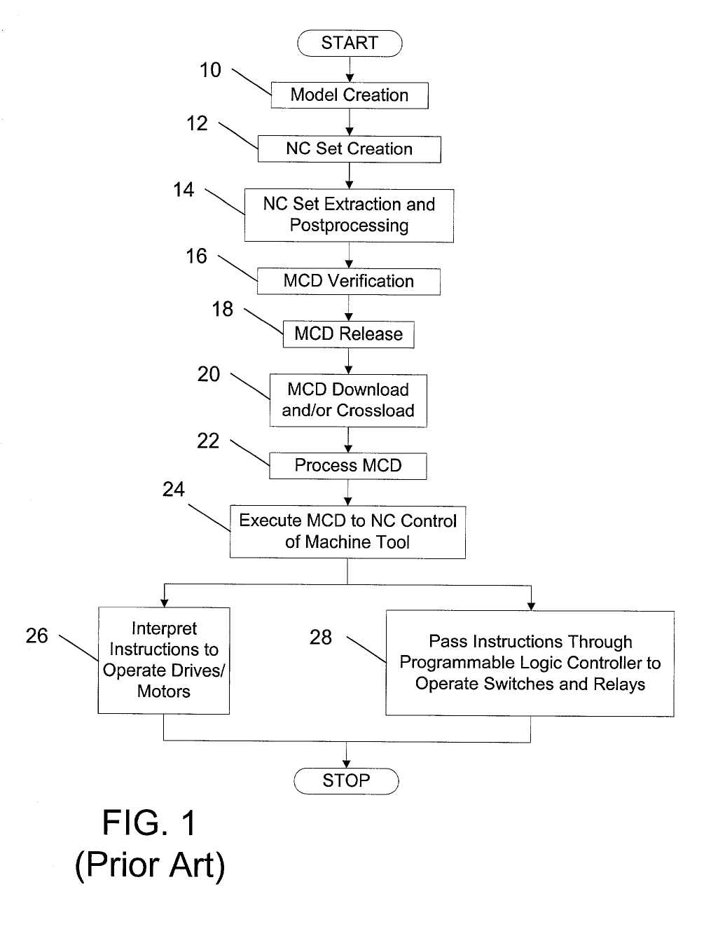

FIG. 2 is a schematic block diagram illustrating the various elements of the system of the present invention, according to one embodiment;

FIG. 3 is a schematic block diagram illustrating the various elements of the setup component of the system of the present invention, according to one embodiment;

FIG. 4 is a schematic block diagram illustrating the various elements of one of the motion command components of the system of the present invention, according to one embodiment; and

FIG. 5 is a flow diagram of one embodiment of the present invention, illustrating some of the various steps in the method for controlling at least one motion device.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

As used throughout, several examples will provide illustrations of the use of the present invention in the manufacturing industry. Specifically, the system, method and computer program product will, at times, be described in conjunction with the manufacturing of a part using a machine tool. It should be understood, however, that the present invention can be utilized in any system including a motion device, where operation of the motion device can be simulated using electronic simulation information, without departing from the spirit and scope of the present invention. For example, in the aerospace industry, the present invention could be utilized with systems such as those operating a terrestrial telescope, for example.

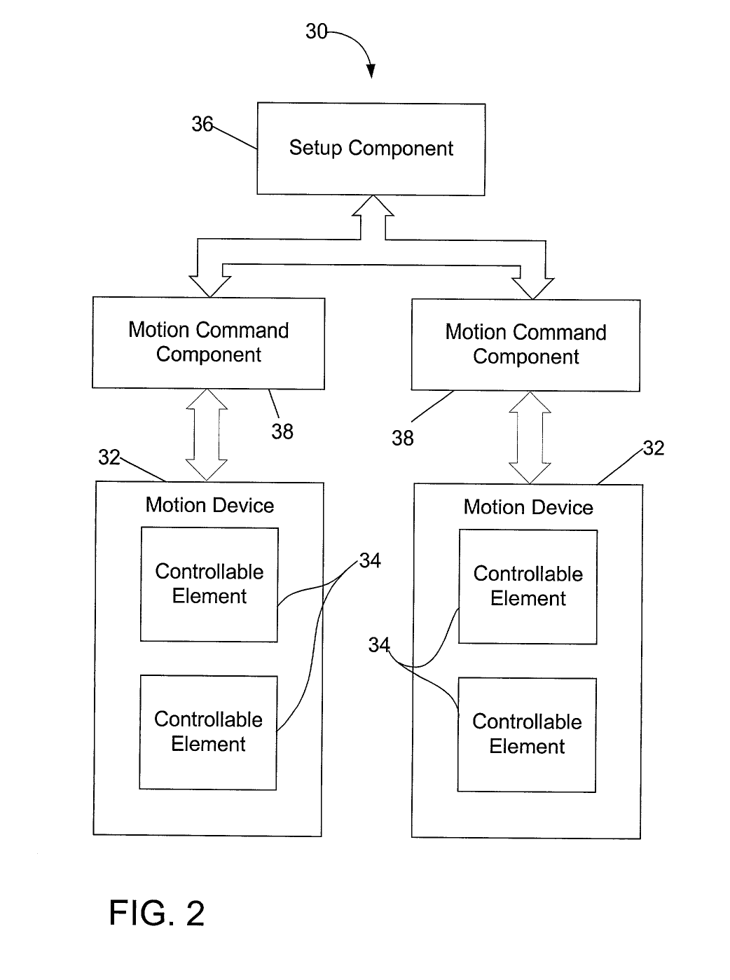

Referring now to FIG. 2, the present invention provides a system 30 for controlling at least one motion device 32 comprising at least one controllable element 34. To control the motion devices, the present invention includes a setup component 36 and at least one motion command component 38. Whereas the illustrated embodiment includes only one motion device connected to each motion command component, it should be understood that each motion command component can be connected to more than one motion device without departing from the spirit and scope of the present invention. As described in more detail below, the setup component processes electronic simulation information into a neutral format such that the electronic simulation information is in a format that is independent of the source of the simulation information. As also described below, each motion command component is capable of receiving the neutral information and thereafter preparing the neutral information. Each motion command component is further capable of distributing the prepared neutral information to the controllable elements of respective motion devices to thereby control the motion devices.

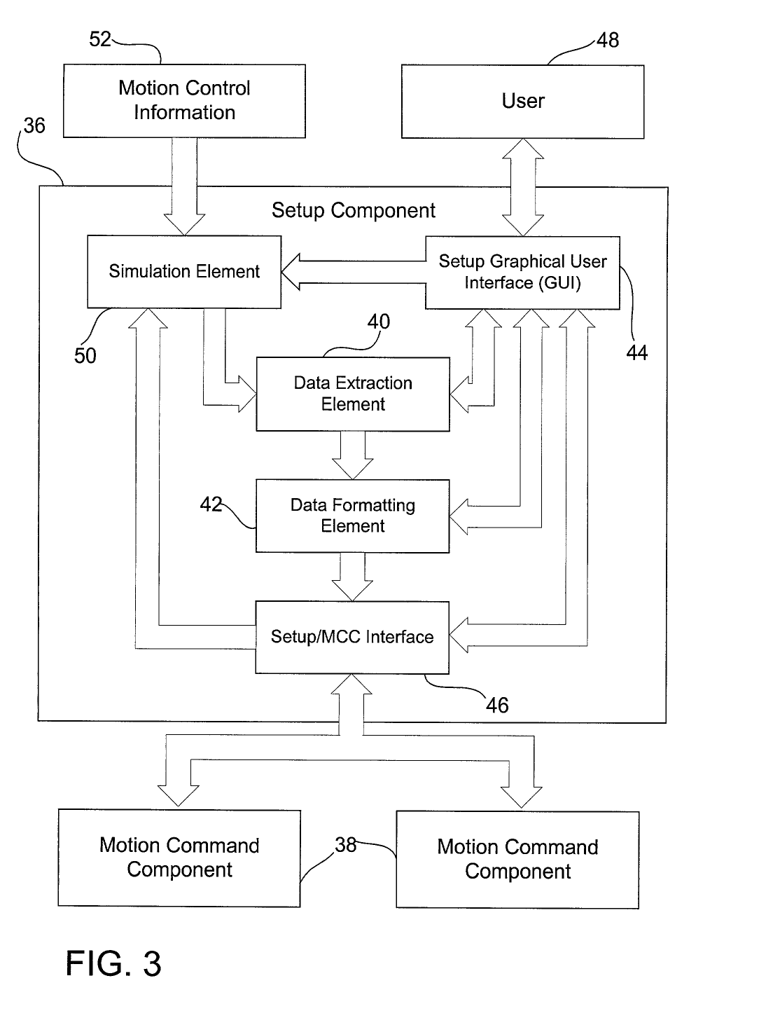

Reference is now made to FIG. 3, which illustrates various elements of the setup component 36, according to one embodiment of the present invention. The setup component can comprise any of a number of different devices, including a personal computer or other high level processor. As stated, the setup component processes electronic simulation information into a neutral format such that the electronic simulation information is in a format that is independent of the source of the simulation information. In this regard, the setup component includes a data extraction element 40 and a data formatting element 42. In addition, to interface with a user and the motion command components (MCC's) 38, the setup component includes a setup graphical user interface (GUI) 44 and a setup/MCC interface 46, respectively.

The setup GUI 44 of the setup component 36 allows a user 48 to interact with the setup component of the system 30. The setup GUI is in communication with and receives input from the data extraction element 40, data formatting element 42 and setup/MCC interface 46 to thereby monitor the operation of the setup component. In this regard, the setup GUI allows the user to manage the operation of the setup component and, thus, operation of the system. The setup GUI allows the user to manually input commands to the setup component for error resolution, such as restarting any of the elements 40, 42, 46 and 50 of the setup component, running diagnostic routines or identifying the motion control information location path for a newly installed setup component. The setup GUI can provide a variety of different feedback information to the user, including identifying the elements of the setup component operating at any given time and whether any of the elements are malfunctioning. For example, the GUI can identify to the user whether the simulation element is formulating the electronic simulation information or simulating the operation of the motion devices. Additionally, the setup GUI can provide feedback from the motion command components 38 through the setup/MCC interface, such as to the motion devices 32 whose operation is being controlled and the current status of the operation of such motion devices and respective controllable elements 34. Moreover, the setup GUI can provide feedback such as the current execution time of a selected motion command component, and can provide diagnostic information relating to the current and/or historic efficiencies of a selected motion command component, including its elements.

Whereas the electronic simulation information can be provided to the setup component for processing, in a preferred embodiment the setup component includes a simulation element 50 for creating the simulation information. The simulation element can comprise any of a number of conventional systems that simulate the operation of a motion system. For example, in the manufacturing industry, the simulation element can comprise conventional software packages such as the VERICUT software package distributed by CGTech of Irvine, Calif. and the CutViewer software package distributed by Progressive Software Corp. of Harrison, Ohio. The simulation element can also comprise part of a conventional computer-aided manufacturing software system, such as the CATIA software package distributed by Dassault Systemes S.A. of Suresnes Cedex, France. Additionally, for a description of a system that could be implemented as the simulation element, see U.S. Pat. No. 4,912,625 issued Mar. 27, 1990 to Glatfelter and assigned to The Boeing Company (the assignee of the present application), the contents of which are hereby incorporated by reference in their entirety.

The simulation element 50 can include, or be provided with, electronic simulation information including motion device information and information respecting any objects the motion device will be operated upon. For example, the electronic simulation information can include information respecting machine tools to be operated including function information of the controllable elements of the machine tool (e.g., programmable logic controller), and information related to the components to be operated upon by the machine tool. The electronic simulation information further includes “high level” motion control information 52 received by the simulation element for use by the setup component of the system. In the manufacturing industry, for example, the simulation element operates with “high level” motion control information consisting of an NC set for the particular component assembly and machine tools used to machine the assembly. The NC set can be created with any known CAM system, such as the CATIA software package distributed by Dassault Systemes S.A. of Suresnes Cedex, France. The “high level” instructions of the NC set typically designate a set of precise end-point locations for motion control during machining each of the features of the component, including those of a pattern, on the component. In contrast, other information included within the electronic simulation information would include function information for the respective machine tools, such as power switching commands for the various switches and relays of the machine tools (although some of this information could be provided by the individual machine control component to operate specific drives and/or motors of specific machine tools).

The simulation element 50 conventionally utilizes the electronic simulation information to allow the user to verify the operation of the motion devices 32 produced by a finished set of operation information, such as the MCD derived from a numerical control program produced from any desired source, including a computer aided manufacturing (CAM) system. Operation of the motion devices can thus be verified prior to use of the operation information itself. In this regard, the simulated operation of the motion device is preferably graphically displayed, such as by an operator GUI 60 (described below) so that its motion can be thereby verified.

To enable the system 30 to further utilize the electronic simulation information to control the motion devices 32, the setup component 36 includes the data extraction element 40 to formulate the electronic simulation information into process information that includes all of the information required to operate the motion devices, such as motion information of the motion devices and function information of the controllable elements of the motion devices. For example, in the manufacturing industry, the NC set provided by the simulation element can be generic for any of a number of different machine tools which may all perform the same function, but consist of different models from different manufactures, for example. Thus, each type of machine tool can include multiple, slightly different function information. For example, each type of machine tool can include information specific to the programmable logic controller (PLC) of the particular machine tool, information specific for the locations of key elements of the machine tool (such as position to change tools), and manufacturer-specific information for functions of other controllable elements of the machine tool.

Also, in the manufacturing industry, the NC set provided can generally comprise a set of discrete end-point locations. But to effectively control the motion devices, more information is required, such as in the case of commanding non-linear motion of the motion devices 32. In this regard, the data extraction element 40 can perform interpolation of points between the end points. To interpolate between the end points of the NC set, the data extraction element calculates a series of small single axis departures of the machine tool from a straight line between the end points.

To enable the motion command component 38 to utilize the process information, the setup component 36 includes the data formatting element 42. The data formatting element inputs the process information, which can be in any number of different formats depending on the format of the electronic simulation information used to derive the process information. From the inputted process information, the data formatting element reformats the process information into neutral process information in a neutral format independent of the format of the electronic simulation information.

For example, an error message in the verification of the process information could contain objects of information such identifying the controllable element causing the error and identifying the location in the process information where the error occurred. However, if the data extraction element provided process information in two different formats from electronic simulation information in two different formats, the formatting of the process information could be different, such as the ordering of the information. In this regard, the data formatting element identifies each piece of information required by the motion command element in what ever format provided by the data extraction element and reformats the information into a uniform, neutral format. In addition, the neutral process information could include an identification of the source of the electronic simulation information. In this regard, assume in one instance the data formatting element input process information in a format from a source of electronic simulation information S1 contained five objects of information in the order O1, O2, O5, O4 and O3. And assume in another instance the data formatting element input process information in another format from another source of electronic simulation information S2 contains the same five objects of information in another order O5, O3, O4, O1 and O2. In either instance, the data formatting element would output the same information in the neutral format in yet another order and could include the source of the information, e.g., S1, O1, O2, O3, O4 and O5 or S2, O1, O2, O3, O4 and O5.

Directing communications transmitted from the setup component 36 to the motion command components 38, and received by the setup component from the motion command components, the setup component includes the setup/MCC interface 46. In this regard, the setup/MCC interface can control the transmission of the neutral process information from the data formatting element 42 of the setup component to respective motion command components. Additionally, the setup/MCC interface can provide the motion command components with status information as to the processing of the motion control information, as well as any user intervention required at any respective motion devices. The setup/MCC interface can also provide the setup GUI 44 with status information from motion command components, such as in the event of an error occurring in one of the motion command components. Further, the setup/MCC interface can provide information to the simulation element 50 of the setup component, such as requiring modification of the electronic simulation information.

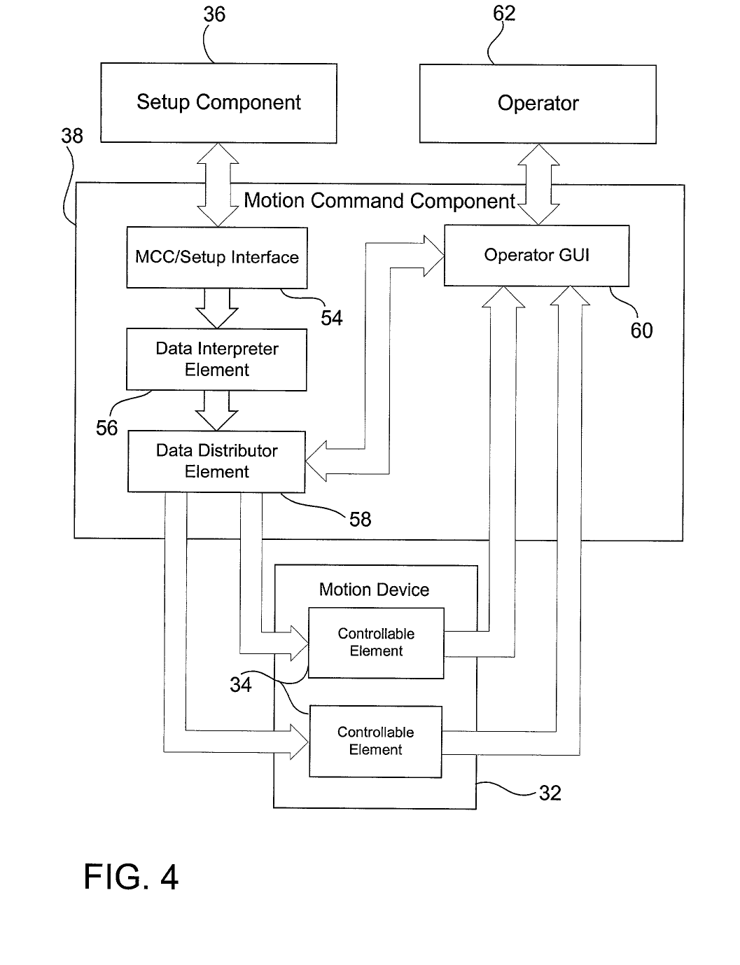

Referring now to FIG. 4 which illustrates various elements of one of the motion command components, the motion command component includes a MCC/setup interface 54. The MCC/setup interface directs communications transmitted from the respective motion command components to the setup component, and received by the motion command component from the setup component.

Drawing attention to FIG. 4, the system further includes the motion command components, which can comprise any number of different devices, such as a personal computer or other high level processor. To allow the system 30 to control respective motion devices 32 utilizing the neutral process information, the motion command component 38 includes a data interpreter element 56 and a data distributor element 58. The data interpreter element is capable of receiving the neutral process information from the MCC/setup interface 54 and further processing the neutral process information. In this regard, the motion command component is in communication with, and controls, at least one motion device 32, which is of a specific type and can include multiple controllable elements 34. And as the type of motion device can vary, so can the format of motion information the controllable elements of each type of motion device are capable of understanding. Therefore, the data interpreter element is capable of reformatting the neutral process information into the format of the motion devices controlled by the respective motion command component, and separating the reformatted operation information into operation information for each controllable element.

As stated, for example, in the manufacturing industry a number of different machine tools can all perform the same function, but consist of different models from different manufacturers. As such, the different models can operate according to operation information in different formats. In such a case, the data interpreter element 56 is capable of reformatting the neutral process information into a format understood by the respective machine tools. Additionally, the data interpreter element is capable of separating the reformatted operation information into operation information for each controllable element of the respective machine tools, such as the PLC and motors/drives.

From the data interpreter element 56, the data distributor element 58 of the motion command component 38 is capable of receiving the reformatted and separated operation information. The data distributor element then distributes the operation information to the respective controllable elements 34 of each motion device 32 connected to the motion command component. As illustrated, the data distributor element is distributing the operation information to one motion device. But it should be understood that the data distributor element is capable of distributing the operation information to multiple controllable elements of multiple motion devices without departing from the spirit and scope of the present invention.

To further enable operation control of the motion command component 38, the motion command component additionally includes an operator GUI 60. The operator GUI can allow an operator 62 to setup the operation of the motion command component, as well as manually enter operation information and/or otherwise override the operation of respective motion devices 32 to thereby control the operation of respective motion devices. Additionally, the operator GUI can be capable of providing feedback to the operator, such as the current state of the motion command component including the progress of the respective motion devices in accordance with the operation information, a positional display of the respective motion devices and/or status of the elements (controllable and other elements) of the respective motion command components, and error messages associated with the operation of the motion command component and/or respective motion devices.

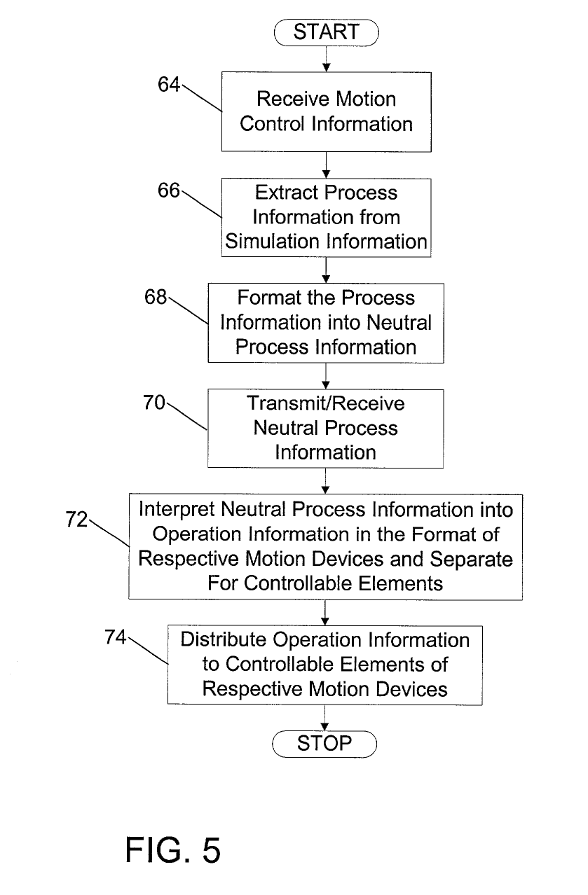

Referring now to FIG. 5, in operation, the simulation element 50 of the setup component 36 receives the motion control information. (Block 64). From the motion control information, the simulation element can formulate the electronic simulation information. Utilizing the electronic simulation information, the simulation element can conventionally simulate the operation of the motion devices 32 to verify the operation of the motion devices. After the simulation information has been formulated, or after the simulation element has verified the operation of the motion devices, the data extraction element 40 extracts the process information from the electronic simulation information. (Block 66). During the extraction step, the data extraction element performs any further processing as required to include all of the information necessary to operate the motion devices.

Once the process information has been extracted from the electronic simulation information, the data formatting element 42 reformats the process information into a neutral format independent of both the format of the electronic simulation information and the format of the operation information that operates the motion devices 32. (Block 68). The neutral process information is then transmitted from the setup component 36 to at least one motion command component 38, which receives the neutral process information. (Block 70). Once received by the motion command components, the data interpreter element 56 of each motion command component interprets the neutral process information into operation information in the format of the respective motion devices in communication with the motion command component. Additionally, the data interpreter element separates the operation information into operation information for each controllable element 34 of the respective motion devices. (Block 72). Once separated, the data distributor element 58 distributes the separated operation information to each controllable element of the respective motion devices to thereby operate the motion devices.

The present invention therefore provides a system, method and computer program product for controlling the operation of a device by directly implementing electronic simulation information. By implementing the electronic simulation information to control the motion of motion devices, the system and method of the present invention eliminates many of the steps in the creation, verification and use of motion device commands, as required by conventional methods. Additionally, by converting the process information into neutral process information, the system and method of the present invention can accept simulation information in multiple different formats and can supply operation information to multiple different motion devices. As such, the system and method of the present invention reduce the amount of resources (in terms of time and money) required to implement and/or modify control of a motion device.

In various advantageous embodiments, portions of the system and method of the present invention include a computer program product. The computer program product includes a computer-readable storage medium, such as the non-volatile storage medium, and computer-readable program code portions, such as a series of computer instructions, embodied in the computer-readable storage medium. Typically, the computer program is stored and executed by a processing unit or a related memory device, such as the setup component 36 and/or motion command components 38 as depicted in FIG. 2.

In this regard, FIGS. 2-5 are block diagram, flowchart and control flow illustrations of methods, systems and program products according to the invention. It will be understood that each block or step of the block diagram, flowchart and control flow illustrations, and combinations of blocks in the block diagram, flowchart and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagram, flowchart or control flow illustrations, and combinations of blocks or steps in the block diagram, flowchart or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of controlling the operation of at least one motion device by directly implementing electronic simulation information, wherein the at least one motion device comprises at least one controllable element, said method comprising:
extracting process information from the electronic simulation information;
formatting the process information into neutral process information, wherein the neutral process information is in a format independent of a format of the electronic simulation information;
interpreting the neutral process information into operation information for each of the at least one controllable element, wherein the operation information depends on a type of the at least one motion device; and
distributing the operation information to the at least one controllable element of the at least one motion device to thereby control the operation of the at least one motion device.

2. A method according to claim 1, wherein the at least one motion device comprises a plurality of motion devices, wherein interpreting comprises interpreting the neutral process information into operation information specific to the type of each of the plurality of motion devices, and wherein distributing comprises distributing the operation information to the at least one controllable element of respective motion devices of the plurality of motion devices.

3. A method according to claim 1, wherein the electronic simulation information comprises electronic simulation information in at least one format, and wherein formatting comprises formatting the process information extracted from the electronic simulation information into the neutral process information in a neutral format independent of the at least one format of the electronic simulation information.

4. A method according to claim 1, wherein the at least one motion device operates according to operation information in at least one format, and wherein interpreting comprises interpreting the neutral process information into operation information in the at least one format of the at least one motion device.

5. A method according to claim 1, wherein the electronic simulation information comprises electronic simulation information in at least one format, wherein the at least one motion device operates according to operation information in at least one format, wherein formatting comprises formatting the process information extracted from the electronic simulation information into the neutral process information in a neutral format independent of the at least one format of the electronic simulation information, and wherein interpreting comprises interpreting the neutral process information into operation information in the at least one format of the at least one motion device.

6. A method according to claim 5, wherein formatting comprises formatting the process information into the neutral process information in a neutral format independent of the at least one format of the electronic simulation information, and further independent of the at least one format of the operation information of the at least one motion device.

7. A method according to claim 1, wherein the at least one motion device comprises at least one machine tool, and wherein distributing comprises distributing the operation information to the at least one machine tool to thereby control the operation of the at least one machine tool.

8. A system for controlling the operation of at least one motion device comprising at least one controllable element, said system comprising:
a setup component capable of extracting process information from electronic simulation information, wherein the electronic simulation information includes information relating to the operation of the at least one motion device, wherein said setup component is further capable of formatting the process information into neutral process information, wherein the neutral process information is in a format independent of a format of the electronic simulation information; and
at least one motion command component capable of receiving the neutral process information from said setup component, wherein each motion command component is associated with at least one motion device, wherein each motion command component is capable of interpreting the received neutral process information into operation information for the at least one controllable element of each respective motion device, wherein the operation information depends on a type of the at least one motion device, and wherein each motion command component is further capable of distributing the operation information to the at least one controllable element of each respective motion device to thereby control the operation of the respective motion devices.

9. A system according to claim 8, wherein the at least one motion device comprises a plurality of motion devices, said setup component is capable of interpreting the neutral process information into operation information specific to the type of each of the plurality of motion devices, and wherein each motion command component is capable of distributing the operation information to the at least one controllable element of each respective motion device of the plurality of motion devices.

10. A system according to claim 8, wherein the electronic simulation information comprises electronic simulation information in at least one format, and wherein said setup component is capable of formatting the process information extracted from the electronic simulation information into the neutral process information in a neutral format independent of the at least one format of the electronic simulation information.

11. A system according to claim 8, wherein the at least one motion device operates according to operation information in at least one format, and wherein each motion command component is capable of interpreting the neutral process information into operation information in the format of each respective motion device.

12. A system according to claim 8, wherein the electronic simulation information comprises electronic simulation information in at least one format, wherein the at least one motion device operates according to operation information in at least one format, wherein said setup component is capable of formatting the process information extracted from the electronic simulation information into the neutral process information in a neutral format independent of the at least one format of the electronic simulation information, and wherein each motion command component is capable of interpreting the neutral process information into operation information in the format of each respective motion device.

13. A system according to claim 12, wherein said setup component is capable of formatting the process information into the neutral process information in a neutral format independent of the at least one format of the electronic simulation information, and further independent of the at least one format of the operation information of the at least one motion device.

14. A system according to claim 8, wherein the at least one motion device comprises at least one machine tool, and wherein each motion command component is capable of distributing the operation information to each respective machine tool to thereby control the operation of the respective machine tools.

15. A computer program product for controlling the operation of at least one motion device by directly implementing electronic simulation information, wherein the at least one motion device comprises at least one controllable element, the computer program product comprising a computer-readable storage medium having computer-readable program code embodied in said medium, the computer-readable program code comprising:
a first executable portion for extracting process information from the electronic simulation information;
a second executable portion for formatting the process information into neutral process information, wherein the neutral process information is in a format independent of a format of the electronic simulation information;
a third executable portion for interpreting the neutral process information into operation information for each of the at least one controllable element, wherein the operation information depends on a type of the at least one motion device; and
a fourth executable portion for distributing the operation information to the at least one controllable element of the at least one motion device to thereby control the operation of the at least one motion device.

16. A computer program product according to claim 15, wherein the at least one motion device comprises a plurality of motion devices, wherein said third executable portion interprets the neutral process information into operation information specific to the type of each of the plurality of motion devices, and wherein said fourth executable portion distributes the operation information to the at least one controllable element of respective motion devices of the plurality of motion devices.

17. A computer program product according to claim 15, wherein the electronic simulation information comprises electronic simulation information in at least one format, and wherein said second executable portion formats the process information extracted from the electronic simulation information into the neutral process information in a neutral format independent of the at least one format of the electronic simulation information.

18. A computer program product according to claim 15, wherein the at least one motion device operates according to operation information in at least one format, and wherein said third executable portion interprets the neutral process information into operation information in the at least one format of the at least one motion device.

19. A computer program product according to claim 15, wherein the electronic simulation information comprises electronic simulation information in at least one format, wherein the at least one motion device operates according to operation information in at least one format, wherein said second executable portion formats the process information extracted from the electronic simulation information into the neutral process information in a neutral format independent of the at least one format of the electronic simulation information, and wherein said third executable portion interprets the neutral process information into operation information in the at least one format of the at least one motion device.

20. A computer program product according to claim 19, wherein said second executable portion formats the process information into the neutral process information in a neutral format independent of the at least one format of the electronic simulation information, and further independent of the at least one format of the operation information of the at least one motion device.

21. A computer program product according to claim 15, wherein the at least one motion device comprises at least one machine tool, and wherein said fourth executable portion distributes the operation information to the at least one machine tool to thereby control the operation of the at least one machine tool.
